(19) United States
(12) Patent Application Publication
(10) Pub. No.: US 2024/0335907 A1
(43) Pub. Date: Oct. 10, 2024

(54) CRYOGENIC LASER SHOCK DEVICE AND METHOD

(71) Applicant: JIANGSU UNIVERSITY, Zhenjiang (CN)

(72) Inventors: Xudong REN, Zhenjiang (CN); Yuze ZHANG, Zhenjiang (CN); Zhaopeng TONG, Zhenjiang (CN); Yongzhou GE, Zhenjiang (CN); Huaile LIU, Zhenjiang (CN); Jiayang GU, Zhenjiang (CN); Jian CHEN, Zhenjiang (CN); Wenbin WAN, Zhenjiang (CN); Haojie YANG, Zhenjiang (CN)

(73) Assignee: JIANGSU UNIVERSITY, Zhenjiang (CN)

(21) Appl. No.: 18/569,238

(22) PCT Filed: Mar. 23, 2023
(86) PCT No.: PCT/CN2023/083263

§ 371 Date: Dec. 12, 2023

(30) Foreign Application Priority Data
Nov. 29, 2022 (CN) 202211505963.8

(51) Int. Cl. B23K 26/356; B23K 26/70

(52) U.S. Cl. CPC B23K 26/356; B23K 26/703

(57) ABSTRACT

A cryogenic laser shock device and method are provided. The device includes a cooling box, a transition chamber, a laser shock chamber, and a master control system. In the method, a sample is cooled by the cooling box, a temperature of the sample is measured in real time by a cryogenic probe, gas in the cooling box is pumped out after the temperature of the sample is stabilized to a set temperature, the cooling box is moved to the laser shock chamber in a vacuum state, and a cryogenic laser shock is implemented through cooperation of a mechanical arm and a three-dimensional motion platform.

### CROSS-REFERENCE TO THE RELATED APPLICATIONS

This application is the national phase entry of International Application No. PCT/CN2023/083263, filed on Mar. 23, 2023, which is based upon and claims priority to Chinese Patent Application No. 202211505963.8, filed on Nov. 29, 2022, the entire contents of which are incorporated herein by reference.

### TECHNICAL FIELD

The present disclosure relates to the field of cryogenic laser shock peening, and particularly to a device and a method for cryogenic laser shock peening of a sample under a vacuum environment.

### BACKGROUND

Laser shock peening, also known as laser peening, is a novel surface strengthening process. Studies have shown that an increase of the dislocation slip resistance of metal materials at ultra-low temperature can effectively improve the threshold for materials to contain high-density dislocations. Laser shock peening of metal materials under cryogenic conditions can produce more dislocations and deformation twins, which can produce a higher strain rate in the materials. Therefore, cryogenic laser peening can produce a good strengthening effect on materials, to significantly improve the surface toughness of metal materials.

At present, cryogenic laser shock peening is to reduce the temperature of the material by heat conduction and then perform laser peening on the sample, and mainly includes fixed-temperature peening and temperature-controllable peening. For fixed-temperature shock peening, the sample is immersed in liquid nitrogen for laser shock. In this method, the temperature is not adjustable, making it difficult to study the relationship between the effect of laser shock and temperature. Moreover, the liquid nitrogen will gasify after absorbing heat, leading to the instant generation of a large number of bubbles and white mist at room temperature, and reducing the light transmittance. A commonly used temperature-controllable method is to continuously and intermittently deliver liquid nitrogen or nitrogen gas to the metal material, and keep the sample in an adjustable low-temperature state for laser shock by controlling the output of liquid nitrogen or nitrogen gas. However, when the sample requires large-batch cryogenic shock, this method wastes a large amount of liquid nitrogen or nitrogen gas, resulting in increased costs. In addition, conventional cryogenic laser shock peening is mainly developed for straight-surface samples, and cryogenic laser shock peening of curved-surface samples is still a technological difficulty.

### SUMMARY

An objective of the present disclosure is to provide a cryogenic laser shock device and method with temperature control in a vacuum environment.

To achieve the above objective of the present disclosure, the following technical solutions are adopted in the present disclosure. A cryogenic laser shock device is provided, including a cooling box, a transition chamber, and a laser shock chamber, where a first automatic door and a second automatic door are arranged on the transition chamber, the second automatic door is located between the transition chamber and the laser shock chamber, the transition chamber and the laser shock chamber are each connected to a vacuum pump through a pumping hose, and a mechanical arm and a laser shock peening device are arranged in the laser shock chamber.

In the above solution, the cooling box is entirely located on a first conveyor belt, a one-dimensional motion platform is arranged in the transition chamber, a second conveyor belt is mounted on the one-dimensional motion platform, a two-dimensional motion platform is arranged in the laser shock chamber, a third conveyor belt is mounted on the two-dimensional motion platform, and the first conveyor belt, the second conveyor belt, and the third conveyor belt are coplanar.

In the above solution, the cooling box includes an upper box body, a lower box body, a nitrogen cylinder, and a vacuum pump, the upper box body is rotatablely connected to the lower box body through a hinge, and the nitrogen cylinder and the vacuum pump are connected to the lower box body through a pipeline system.

In the above solution, an electric lifting motor and an interlayer are arranged in the lower box body, the electric lifting motor passes through the interlayer and is connected to a support plate in the interlayer, and a cryogenic probe is mounted on the support plate.

In the above solution, an endoscopic device is provided on the upper box body; the endoscopic device includes a hollow end cap, a first high-pressure-resistant glass, a second high-pressure-resistant glass, a pressing block, and a second vacuum valve mounted on one side of an outer wall of the upper box body; the second high-pressure-resistant glass is tightly pressed and fixed in a light transmission hole of the upper box body by the pressing block; the hollow end cap is threadedly engaged with the upper box body, to tightly press the first high-pressure-resistant glass onto the light transmission hole of the upper box body; the first high-pressure-resistant glass and the second high-pressure-resistant glass are mounted in the light transmission hole of the upper box body; and a washer is mounted at a contact surface of each of the first high-pressure-resistant glass and the second high-pressure-resistant glass with the upper box body.

In the above solution, the pipeline system includes a pressure reducing valve, a quick joint, a second solenoid valve, a pressure relief valve, a first vacuum valve, and a third vacuum valve; the pressure reducing valve is mounted between the nitrogen cylinder and the quick joint; the second solenoid valve is mounted on a top surface of the upper box body; the quick joint is mounted above the second solenoid valve; when the quick joint is disconnected, the upper box body is separated from a metal hose; the pressure relief valve is mounted on the top surface of the upper box body; the first vacuum valve is mounted on the top surface of the upper box body; and when a temperature of a sample is lowered to a set temperature T, the vacuum pump pumps out, through a pumping hose, gas in a cooling chamber formed between the upper box body and the interlayer.

In the above solution, a lifting lug is fixed to the upper box body, a support block is fixed to the lower box body, one end of a movable connecting rod is movably connected to the lifting lug, an other end of the movable connecting rod is movably connected to a top of an electric push-pull bar, and a bottom of the electric push-pull bar is fixedly connected to the support block.

In the above solution, the first automatic door, the second automatic door, the first solenoid valve, the vacuum pump, the first conveyor belt, the second conveyor belt, the one-dimensional motion platform, the third conveyor belt, the two-dimensional motion platform, the mechanical arm, the three-dimensional motion platform, a pulsed laser emitter, a servo motor, and a third solenoid valve are all connected to a first computer through a first controller; and the cryogenic probe is connected to a second computer through a temperature sensor and is configured to measure the temperature of the sample in real time.

The present disclosure also provides a cryogenic laser shock method using the above cryogenic laser shock device, including the following steps: S1: opening the upper box body, raising the support plate, placing a sample having an absorption layer on the support plate, then lowering the support plate, and closing the upper box body; S2: opening the pressure relief valve and the second solenoid valve through a cryogenic control device to control a flow rate of nitrogen gas introduced into the cooling chamber; after a temperature of the sample is stabilized to T° C., controlling the second computer to close the pressure relief valve and the second solenoid valve; then turning on the vacuum pump to pump out gas in the cooling chamber; after the gas in the cooling chamber is pumped out, disconnecting the quick joint from the pumping hose, and placing the cooling box on the first conveyor belt; S3: opening the first automatic door through the first computer, transporting the cooling box from the first conveyor belt to the second conveyor belt, then closing the first automatic door, opening the first solenoid valve, and pumping out gas in the transition chamber; S4: opening the second automatic door, transporting the sample to the third conveyor belt, opening the upper box body through a box movement device, raising the support plate, then taking out the sample by the mechanical arm, transporting the sample to a position such that an end surface of a shock head end cap is 15 mm to 25 mm away from the sample to be peened, adjusting a laser energy, a laser spot diameter, a laser frequency, a laser pulse width, and a laser spot overlap rate, then performing pre-shocking in the laser shock chamber in a vacuum state for 2 min, and performing laser shock peening; and S5: after the shock peening is completed, placing the sample on the support plate, then lowering the support plate, mounting the upper box body, transporting the cooling box to the second conveyor belt, then closing the second automatic door, opening the first automatic door, transporting the cooling box to the first conveyor belt, finally taking out the sample so that an entire shock process is completed, turning off all the devices, and repeating S1 to S5 to implement a next shock process.

The present disclosure has the following advantages. (1) By continuously and controllably introducing low-temperature nitrogen gas into the cooling box, the sample reaches a low temperature, and the temperature is fed back to the second computer control system in real time through the cryogenic probe and the temperature sensor. The cooling is stopped when the temperature drops to the set temperature, the gas in the box is pumped out. In this way, cryogenic temperature control is realized. The sample is placed in vacuum environment for laser shock, to avoid heat conduction of the sample and realize cryogenic laser shock with temperature control.

The arrangement of the transition chamber in front of the laser shock chamber reduces the amount of gas pumped out during vacuuming. The arrangement of the automatic door, the mechanical motion device, and the mechanical arm realizes the cryogenic shocking of curved-surface samples and improves the working efficiency of large-batch cryogenic shock. (2) In the method of the present disclosure, the sample is cooled by the cooling box, the temperature of the sample is measured in real time by the cryogenic probe, gas in the cooling box is pumped out after the temperature of the sample is stabilized to the set temperature, the cooling box is moved to the laser shock chamber in the vacuum state, and a cryogenic laser shock is implemented through cooperation of the mechanical arm and the three-dimensional motion platform. First, the problem of insufficient light transmission caused by direct contact of liquid nitrogen and the sample is avoided, so that the sample can be subjected to cryogenic laser shock peening in a vacuum environment. In addition, cryogenic laser shock peening can be performed on a metal material in a sample temperature range of 0° C. to −190° C. Furthermore, the present disclosure is suitable for performing cryogenic laser shock peening on straight-surface and curved-surface samples. Moreover, the present disclosure is suitable for large-batch cryogenic laser shock, and can reduce the shock peening costs.

### BRIEF DESCRIPTION OF THE DRAWINGS

FIG. 1 is a schematic diagram of an overall structure of a device according to the present disclosure.

FIG. 2 is a schematic structural diagram of a cooling box.

FIG. 3 is a schematic structural diagram of a laser transmission system.

FIG. 4 is a schematic diagram of a laser shock operation.

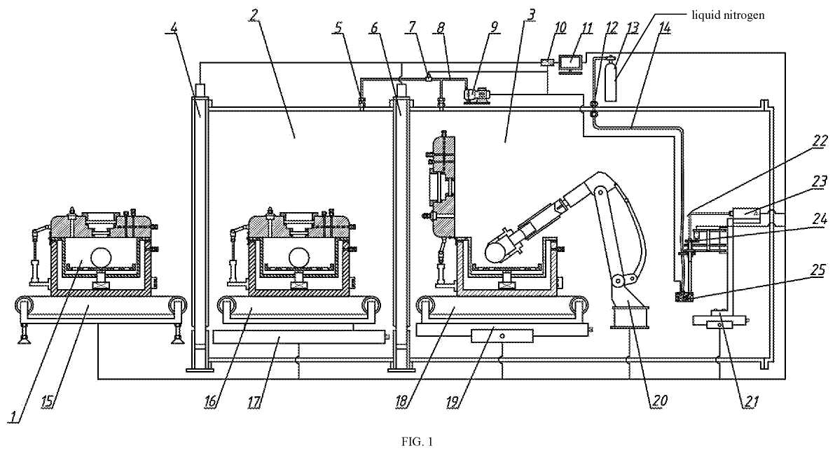

In FIG. 1: 1. cooling box; 2. transition chamber; 3. laser shock chamber; 4. first automatic door; 5. pipe joint; 6. second automatic door; 7. first solenoid valve; 8. pumping hose; 9. vacuum pump; 10. first controller; 11. first computer; 12. pipe joint; 13. liquid nitrogen tank; 14. metal hose; 15. first conveyor belt; 16. second conveyor belt; 17. one-dimensional motion platform; 18. third conveyor belt; 19. two-dimensional motion platform; 20. mechanical arm; 21. three-dimensional motion platform; 22. total reflection mirror; 23. pulsed laser emitter; 24. transmission system; 25. laser shock head.

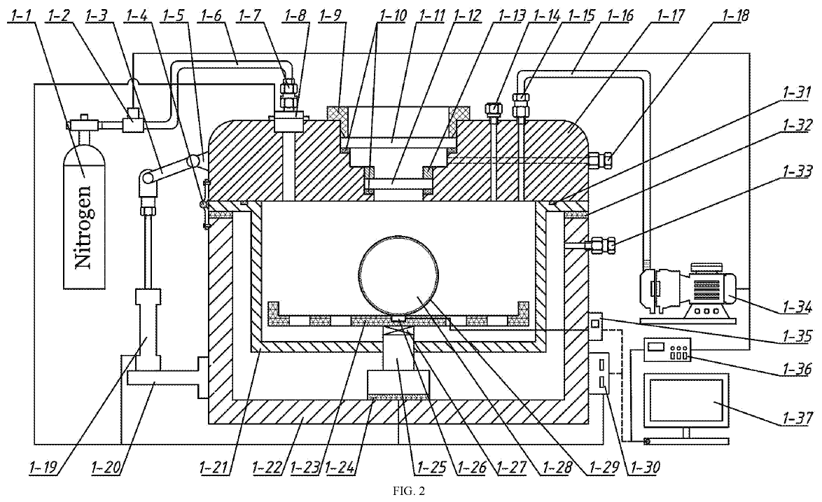

In FIG. 2: 1-1. nitrogen cylinder; 1-2. pressure reducing valve; 1-3. movable connecting rod; 1-4. hinge; 1-5. lifting lug; 1-6. metal hose; 1-7. quick joint; 1-8. second solenoid valve; 1-9. hollow end cap; 1-10. washer; 1-11. first high-pressure-resistant glass; 1-12. second high-pressure-resistant glass; 1-13. pressing block; 1-14. pressure relief valve; 1-15. first vacuum valve; 1-16. pumping hose; 1-17. upper box body; 1-18. second vacuum valve; 1-19. electric push-pull bar; 1-20. support block; 1-21. interlayer; 1-22. lower box body; 1-23. support plate; 1-24. plastic pad; 1-25. electric lifting motor; 1-26. cryogenic probe; 1-27. connecting block; 1-28. sample; 1-29. absorption layer; 1-30. self-powered controller; 1-31. plastic strip; 1-32. plastic pad; 1-33. third vacuum valve; 1-34. vacuum pump; 1-35. temperature sensor; 1-36. second controller; 1-37. second computer.

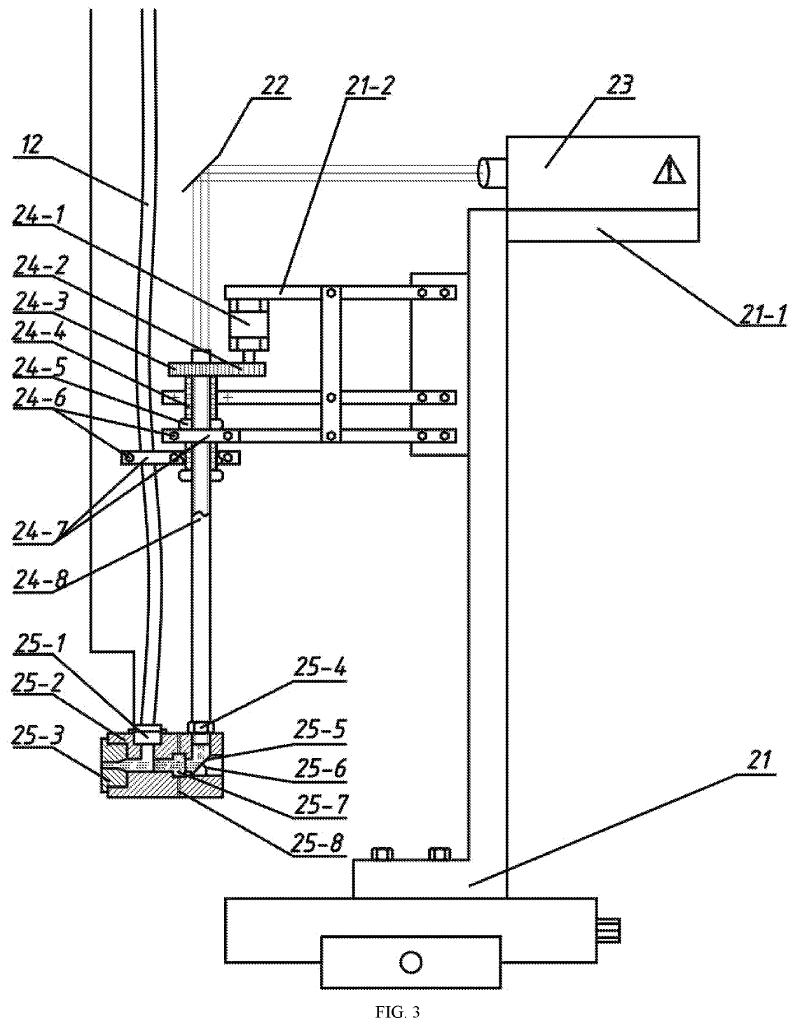

In FIG. 3: 21. three-dimensional motion platform; 21-1. laser emitter support block; 21-2. fixing frame; 24-1. servo motor; 24-2. driving wheel; 24-3. driven wheel; 24-4. long bearing; 24-5. shaft shoulder; 24-6. bolt; 24-7. compression block; 24-8. hollow long shaft; 25-1. third solenoid valve; 25-2. shock head body; 25-3. shock head end cap; 25-4. fastening nut; 25-5. small-sized total reflection mirror; 25-6. total reflection mirror support frame; 25-7. T-shaped glass block; 25-8. plastic pad.

### DETAILED DESCRIPTION OF THE EMBODIMENTS

The present disclosure will be further described in detail below with reference to drawings and embodiments, but the protection scope of the present disclosure is not limited thereto.

As shown in FIG. 1, the present disclosure provides a cryogenic laser shock device, which includes a cooling box 1, a transition chamber 2, a laser shock chamber 3, and a master control system.

As shown in FIG. 2, the cooling box 1 includes a cryogenic control device, a box movement device, an endoscopic device, and a second computer control system. The cryogenic control device includes a high-pressure nitrogen cylinder 1-1, a pressure reducing valve 1-2, a quick joint 1-7, a second solenoid valve 1-8, a pressure relief valve 1-14, a first vacuum valve 1-15, a third vacuum valve 1-33, a vacuum pump 1-34, and a cryogenic probe 1-26 mounted inside a support plate 1-23. The pressure reducing valve 1-2 is mounted between the nitrogen cylinder 1-1 and the quick joint 1-7, and is configured to control a flow rate of nitrogen gas introduced into the cooling box 1. The second solenoid valve 1-8 is mounted on a top surface of the upper box body 1-17, and is configured to block the inflow of nitrogen gas after a sample 1-28 is cooled to a set temperature. The quick joint 1-7 is mounted above the second solenoid valve 1-8, and when the quick joint is disconnected, the upper box body 1-17 can be separated from a metal hose 1-6. The pressure relief valve 1-14 is mounted on the top surface of the upper box body 1-17, and is configured to discharge nitrogen gas that absorbs heat expands in the upper box body 1-17. The first vacuum valve 1-15 is mounted on the top surface of the upper box body 1-17. When a temperature of the sample 1-28 is lowered to a set temperature T, the vacuum pump 1-34 may pump out, through a pumping hose 1-16, gas in a cooling chamber formed between the upper box body 1-17 and the interlayer 1-21. A plastic pad 1-32 is mounted between the interlayer 1-21 and the lower box body 1-22 to realize sealing connection. The cryogenic probe 1-26 is connected to a second computer 1-37 through a temperature sensor 1-35 and is configured to measure the temperature of the sample 1-28 in real time.

The box movement device includes an electric push-pull bar 1-19, a support block 1-20, a movable connecting rod 1-3, a hinge 1-4, a lifting lug 1-5, an electric lifting motor 1-25, and a connecting block 1-27 mounted between the electric lifting motor 1-25 and the support plate 1-23. The support block 1-20 is mounted on a side surface of the lower box body 1-22. The lifting lug 1-5 is arranged on a side surface of the upper box body 1-17 and is on the same side as the support block 1-20. One end of a movable connecting rod 1-3 is movably connected to the lifting lug 1-5, and an other end of the movable connecting rod 1-3 is movably connected to a top of an electric push-pull bar 1-19. A bottom of the electric push-pull bar 1-19 is fixedly connected to the support block 1-20. A bottom of the electric lifting motor 1-25 is connected to an inner wall of the lower box body 1-22, and a plastic pad 1-24 is mounted at the junction of the bottom of the electric lifting motor 1-25 and the inner wall of the lower box body 1-22. The hinge is arranged between the upper box body and the lower box body and is configured to ensure that the upper box body 1-17 can be normally opened and closed. The connecting block 1-27 is configured to connect the electric lifting motor 1-25 and the support plate 1-23, so that ascending or descending of a lifting column drives the support plate 1-23 to ascend or descend. The box movement device is controlled by the second computer 1-37, and can control the opening and closing of the upper box body 1-17 and the lifting of the support plate 1-23 connected to the electric lifting motor 1-25.

The endoscopic device includes a hollow end cap 1-9, a first high-pressure-resistant glass 1-11, a second high-pressure-resistant glass 1-12, a pressing block 1-13, and a second vacuum valve 1-18 mounted on one side of an outer wall of the upper box body 1-17. The endoscopic device is configured for observing the sample 1-28 in the cooling box during cooling. The second high-pressure-resistant glass 1-12 is tightly pressed and fixed in a light transmission hole of the upper box body 1-17 by the pressing block 1-13. The hollow end cap 1-9 is threadedly engaged with the upper box body 1-17, to tightly press the first high-pressure-resistant glass onto the light transmission hole of the upper box body 1-17. The first high-pressure-resistant glass 1-11 and the second high-pressure-resistant glass 1-12 are mounted in the light transmission hole of the upper box body 1-17. A washer 1-10 is mounted at a contact surface of each of the first high-pressure-resistant glass 1-11 and the second high-pressure-resistant glass 1-12 with the upper box body 1-17. The second vacuum valve 1-18 on the side of the outer wall of the upper box body 1-17 is configured to pump out gas between the first high-pressure-resistant glass and the second high-pressure-resistant glass, to prevent the formation of mist or ice on the first high-pressure-resistant glass 1-11 due to low temperature to affect the observation of the sample 1-28 in the cooling box 1. The second solenoid valve 1-8, the electric push-pull bar 1-19, and the electric lifting motor 1-25 are all wirelessly connected to the second computer 1-37 through a self-powered controller 1-30. The self-powered controller 1-30 is mounted on one side of an outer wall of the lower box body 1-22. The pressure reducing valve 1-2 and the vacuum pump 1-34 are connected to the second computer 1-37 through a second controller 1-36.

The transition chamber 2 includes a second conveyor belt 16 and a one-dimensional motion platform 17. Through left-right movement of the one-dimensional motion platform 17, the second conveyor belt 16 mounted on the one-dimensional motion platform 17 may be respectively butt-joined to a first conveyor belt 15 and a third conveyor belt 18, so that the cooling box 1 can be transported from the first conveyor belt 15 to the third conveyor belt 18 when the first automatic door 4 and the second automatic door 6 are open.

The laser shock chamber 3 includes the third conveyor belt 18, a two-dimensional motion platform 19, a mechanical arm 20, a three-dimensional motion platform 21, and a laser shock device. The laser shock device includes liquid nitrogen 13, a metal hose 14, a total reflection mirror 22, a pulsed laser emitter 23, a transmission system 24, and a laser shock head 25. The pulsed laser emitter 23, the transmission system 24, and the laser shock head 25 are mounted on the three-dimensional motion platform 21. The third conveyor belt 18 is mounted on the two-dimensional motion platform 19. In the laser shock chamber 3, the two-dimensional motion platform 19, the mechanical arm 20, and the three-dimensional motion platform 21 are sequentially mounted on the side close to the second automatic door 6. Through front-rear and left-right two-dimensional movement of the two-dimensional motion platform 19, the cooling box 1 may be butt-joined to the mechanical arm 20. A specific temperature insulation clamp may be mounted on the mechanical arm 20 to take out the sample 1-28 in the cooling box 1. Cryogenic laser shock peening is performed on the sample 1-28 under the action of the laser shock device and the three-dimensional motion platform 21. The first automatic door 4, the second automatic door 6, the first solenoid valve 7, the vacuum pump 9, the first conveyor belt 15, the second conveyor belt 16, the one-dimensional motion platform 17, the third conveyor belt 18, the two-dimensional motion platform 19, the mechanical arm 20, the three-dimensional motion platform 21, a pulsed laser emitter 23, a servo motor 24-1, and a third solenoid valve 25-1 are all connected to a first computer 11 through a first controller 10.

The master control system includes the first controller 10, the first computer 11, the self-powered controller 1-30, the second controller 1-36, and the second computer 1-37.

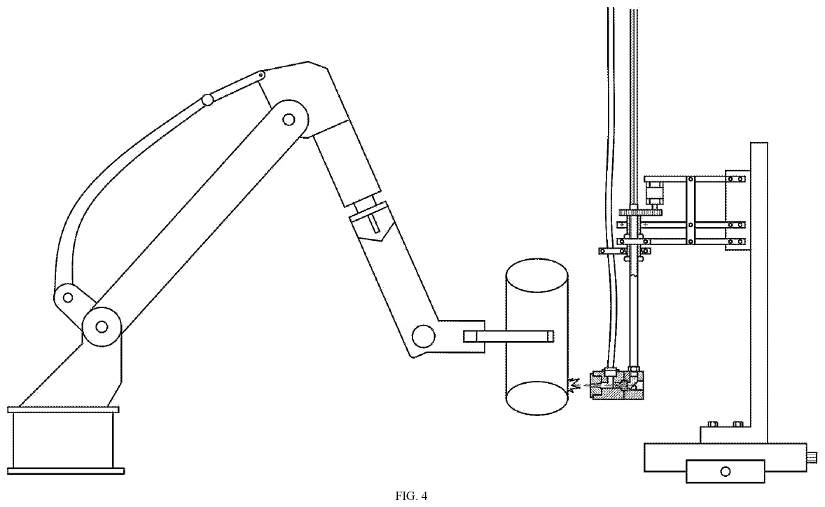

As shown in FIG. 3 and FIG. 4, the transmission system 24 includes the servo motor 24-1, a driving wheel 24-2, a driven wheel 24-3, a long bearing 24-4, and a hollow long shaft 24-8. A bottom of the servo motor 24-1 is fixedly connected to a fixing frame 21-2. A motor output shaft is securely connected to the driving wheel 24-2. The driven wheel 24-3 meshes with the driving wheel 24-2. An inner ring of the driven wheel 24-3 is securely connected to an outer wall of the hollow long shaft 24-8, so that rotation of the driven wheel 24-3 drives the hollow long shaft 24-8 to rotate together. End faces of the two long bearings 24-4 are limited by a shaft shoulder 24-5. The two long bearings 24-4 are fixed to the hollow long shaft 24-8. An inner ring of the long bearing 24-4 is securely engaged with the hollow long shaft, and an outer ring of the long bearing 24-4 is fixed to the fixing frame 21-2 by the joint action of a compression block 24-7 and a bolt 24-6; The fixing frame 21-2 is fixed to a lifting block of the three-dimensional motion platform 21, and can drive the hollow long shaft 24-8 and the laser shock head 25 to move vertically.

The laser shock head 25 includes the third solenoid valve 25-1, a shock head body 25-2, a shock head end cap 25-3, a small-sized total reflection mirror 25-5, a total reflection mirror support frame 25-6, and a T-shaped glass block 25-7. The laser shock head 25 is fixed to one end of the hollow long shaft 24-8 by a fastening nut 25-4. The third solenoid valve 25-1 is mounted on the shock head body 25-2 and can control a flow rate of liquid nitrogen flowing out of a liquid nitrogen tank 13 through the metal hose 14. The shock head end cap 25-3 is mounted on the shock head body 25-2 through threaded engagement. A size of a central hole of the shock head end cap 25-3 is adjustable through the replacement of the shock head end cap 25-3 according to a size of a laser spot. A center of the small-sized total reflection mirror 25-5 coincides with a center line of the hollow long shaft 24-8. The small-sized total reflection mirror is fixed obliquely at 45° in the shock head body 25-2 through the total reflection mirror support frame 25-6. The T-shaped glass block 25-7 is mounted in the shock head body 25-2 to ensure that liquid nitrogen is ejected from the central hole of the shock head end cap 25-3.

Further, the third vacuum valve 1-33 is mounted on one side of the outer wall of the lower box body 1-22. Before the sample 1-28 is cooled, gas in a vacuum chamber formed between the interlayer 1-21 and the lower box body 1-22 may be pumped out by a vacuum pump and a pumping hose, and the vacuum chamber can reduce the heat conduction in the box body. Further, before the sample 1-28 is put into the cooling box 1, an absorption layer needs to be coated on a region area requiring laser peening. The absorption layer is black paint, and a thickness of the absorption layer is less than 20 μm. Further, the temperature T of the sample 1-28 in the cooling box 1 may be controlled at any temperature ranging from 0° C. to −190° C. Further, through the endoscopic device of the upper box body 1-17, the cooling of the sample 1-28 in the cooling box 1 can be observed at any time. Further, a plurality of small holes are drilled on the support plate 1-23 to facilitate circulation of nitrogen gas. The support plate 1-23 is made of plastic, and a length of the support plate 1-23 is less than a length of an inner wall of the interlayer 1-21. Further, there are two movable connecting rods 1-3, two hinges 1-4, two lifting lugs 1-5, two electric push-pull bars 1-19, and two support blocks 1-20, which are mounted at a front portion and a rear portion of a side surface of the cooling box 1. Further, the driving wheel 24-2 and the driven wheel 24-3 have a transmission ratio of 36:1. By controlling a rotation angle of the servo motor 24-1, rotation angles of the hollow long shaft 24-8 and the laser shock head 25 can be precisely controlled. Further, a diameter D of the central hole of the shock head end cap 25-3 may be controlled at any value ranging from 2 mm to 10 mm. The diameter D of the central hole of the shock head end cap 25-3 should be greater than a light spot diameter d. Further, the vacuum pump 9 is respectively connected to the transition chamber 2 and the laser shock chamber 3 through a pumping hose 8, and the first solenoid valve 7 is mounted on the pumping hose 8 of the transition chamber 2. When the first automatic door 4 is open and the second conveyor belt 16 on the one-dimensional motion platform 17 is butt-joined to the first conveyor belt 15, the first solenoid valve 7 is closed and the vacuum pump 9 stops vacuuming the transition chamber 2. Before the first automatic door 4 is closed and the second automatic door 6 is opened, the first solenoid valve 7 is opened, and the vacuum pump 9 vacuumizes the transition chamber 2. After gas in the transition chamber 2 is pumped out, the second automatic door 6 is opened, and the second conveyor belt 16 on the one-dimensional motion platform 17 is butt-joined to the third conveyor belt 18, so that the cooling box 1 on the second conveyor belt 16 can be butt-joined and transported to the third conveyor belt 18 in a vacuum state. Further, the vacuum pump 9 continuously vacuumizes the laser shock chamber 3, to ensure that the laser shock chamber 3 is continuously in a vacuum state and almost no heat conduction occurs in the sample 1-28. After the cooling box 1 enters the laser shock chamber 3, the electric push-pull bars 1-19 is retracted to drive the movable connecting rod 1-3 to open the upper box body 1-17, and the mechanical arm takes out the sample 1-28 for shock peening. Further, during the shock peening, the three-dimensional motion platform 21 is responsible for controlling the vertical movement and the circumferential movement of the laser shock head 25, and the mechanical arm 20 is responsible for controlling a surface of the sample 1-28 to be peened perpendicular to the center line of the central hole of the shock head end cap 25-3, and controlling an end surface of the shock head end cap 25-3 to keep a distance from the surface of the specimens 1-28 to be peened. Further, during the laser shock peening, the end face of the shock head end cap 25-3 is kept at a distance of 15 mm to 25 mm from the surface of the sample 1-28 to be peened. At the time of opening of the third solenoid valve 25-1, the laser shock chamber 3 is in a vacuum state, and liquid nitrogen can be ejected from the central hole of the shock head end cap 25-3. Further, after the absorption layer 1-29 absorbs laser energy emitted by the pulsed laser emitter 23, local plasma explosion occurs. By controlling opening frequencies of and an opening time difference between the pulsed laser emitter 23 and the third solenoid valve 25-1, laser beams and liquid nitrogen can reach the surface of the sample 1-28 at the same time, so that a shock wave induced by the laser beams can be restricted. The liquid nitrogen volatilizes instantly after each shock peening in a vacuum environment, and the contact between the liquid nitrogen and the sample 1-28 lasts for an extremely short duration, which is insufficient for heat conduction between the liquid nitrogen and the sample 1-28. Therefore, the sample 1-28 is still kept at the temperature at the time of being taken out of the cooling box 1. The opening frequencies of the pulsed laser emitter 23 and the third solenoid valve 25-1 need to be consistent, and the opening time difference may be measured by special equipment before the shock peening and centrally controlled by the first computer 11.

In this embodiment, taking an aluminum (Al) alloy as an example, laser shock using the cryogenic laser shock device of this embodiment specifically includes the following steps: A. A hollow pipe with an inner diameter of 140 mm, a wall thickness of 4 mm, and a length of 220 mm is used as a sample. The upper box body 1-17 is opened through the box movement device. The support plate 1-23 is raised. A sample 1-28 coated with a thick black paint of 18 μm is placed on the support plate 1-23. Then the support plate 1-23 is lowered, and the upper box body 1-17 is closed. B. The pressure relief valve 1-14 and the second solenoid valve 1-8 are opened through a cryogenic control device. High-pressure nitrogen is first introduced into the cooling chamber at a flow rate of 10 L/min. When the temperature of the sample 1-28 reaches −160° C., the flow rate of nitrogen gas is halved. When the temperature of the sample 1-28 reaches −170° C., the pressure relief valve 1-14 is closed to stop the introduction of nitrogen gas, and the temperature is kept for 2 min. During this period, if the temperature of the sample 1-28 is higher than −170° C., nitrogen gas is introduced again at a flow rate of 5 L/min until the temperature of the sample 1-28 is stabilized at −170° C. Then, the second computer 1-37 is controlled to close the pressure relief valve 1-14 and the second solenoid valve 1-8. The vacuum pump 1-34 is turned on to pump out gas in the cooling chamber. The quick joint 1-7 is disconnected from the pumping hose 1-16. The cooling box 1 is placed on the first conveyor belt 15. C. The first automatic door 4 is opened through the first computer 11. The cooling box 1 is transported to the second conveyor belt 16. Then, the first automatic door 4 is closed, the first solenoid valve 7 is opened, and gas in the transition chamber 2 is pumped out. D. After the transition chamber 2 reaches a vacuum state, the second automatic door 6 is opened, the sample 1-28 is transported to the third conveyor belt 18, the upper box body 1-17 is opened through the box movement device, and the support plate 1-23 is raised. Then, the sample 1-28 is taken out by the mechanical arm 20 equipped with a temperature insulation clamp, and transported to a position that is on an outer wall of the pipe and that is 20 mm away from an end surface of the shock head end cap 25-3. Laser energy is adjusted to 10 J, a laser spot diameter is adjusted to 3 mm, a laser frequency is adjusted to 1 Hz, and a laser spot overlap rate is adjusted to 50%. E. A difference between arrival times of liquid nitrogen and the laser at the surface to be peened that are measured by special equipment in advance is input into the first computer 11. An opening frequency of the third solenoid valve 25-1 is adjusted to 1 Hz. The mechanical arm is responsible for circular movement. The laser shock head is responsible for vertical movement, first performs pre-shocking for 2 min, and then starts to perform laser shock peening on the outer wall of the pipe. F. After shock peening of one circle is completed, shock peening of a next circle is implemented by repeating the above steps, until shock peening of the entire region to be peened is completed.

The embodiments are preferred embodiments of the present disclosure, but the present disclosure is not limited to the above-mentioned embodiments. For example, when laser shock peening is performed on the inner wall of the pipe, the mechanical arm is responsible for vertical movement, and the laser shock head is responsible for circular movement. Without departing from the essence of the present disclosure, any obvious improvement, replacement, or variation that can be made by those skilled in the art without departing from the principle and spirit of the present disclosure fall within the protection scope of the present disclosure.

What is claimed is:

1. A cryogenic laser shock device, comprising a cooling box, a transition chamber, and a laser shock chamber, wherein a first automatic door and a second automatic door are arranged on the transition chamber, the second automatic door is located between the transition chamber and the laser shock chamber, the transition chamber and the laser shock chamber are each connected to a vacuum pump through a pumping hose, and a mechanical arm and a laser shock peening device are arranged in the laser shock chamber.

2. The cryogenic laser shock device according to claim 1, wherein the cooling box is entirely located on a first conveyor belt, a one-dimensional motion platform is arranged in the transition chamber, a second conveyor belt is mounted on the one-dimensional motion platform, a two-dimensional motion platform is arranged in the laser shock chamber, a third conveyor belt is mounted on the two-dimensional motion platform, and the first conveyor belt, the second conveyor belt, and the third conveyor belt are coplanar.

3. The cryogenic laser shock device according to claim 2, wherein the cooling box comprises an upper box body, a lower box body, a nitrogen cylinder, and a vacuum pump, the upper box body is rotatablely connected to the lower box body through a hinge, and the nitrogen cylinder and the vacuum pump are connected to the lower box body through a pipeline system.

4. The cryogenic laser shock device according to claim 3, wherein an electric lifting motor and an interlayer are arranged in the lower box body, the electric lifting motor passes through the interlayer and is connected to a support plate in the interlayer, and a cryogenic probe is mounted on the support plate.

5. The cryogenic laser shock device according to claim 4, wherein an endoscopic device is provided on the upper box body;
the endoscopic device comprises a hollow end cap, a first high-pressure-resistant glass, a second high-pressure-resistant glass, a pressing block, and a second vacuum valve mounted on one side of an outer wall of the upper box body;
the second high-pressure-resistant glass is tightly pressed and fixed in a light transmission hole of the upper box body by the pressing block;
the hollow end cap is threadedly engaged with the upper box body, to tightly press the first high-pressure-resistant glass onto the light transmission hole of the upper box body;
the first high-pressure-resistant glass and the second high-pressure-resistant glass are mounted in the light transmission hole of the upper box body; and
a washer is mounted at a contact surface of each of the first high-pressure-resistant glass and the second high-pressure-resistant glass with the upper box body.

6. The cryogenic laser shock device according to claim 5, wherein the pipeline system comprises a pressure reducing valve, a quick joint, a second solenoid valve, a pressure relief valve, a first vacuum valve, and a third vacuum valve;
the pressure reducing valve is mounted between the nitrogen cylinder and the quick joint;
the second solenoid valve is mounted on a top surface of the upper box body;
the quick joint is mounted above the second solenoid valve;
when the quick joint is disconnected, the upper box body is separated from a metal hose;
the pressure relief valve is mounted on the top surface of the upper box body;
the first vacuum valve is mounted on the top surface of the upper box body; and
when a temperature of a sample is lowered to a set temperature T, the vacuum pump pumps out, through a pumping hose, gas in a cooling chamber formed between the upper box body and the interlayer.

7. The cryogenic laser shock device according to claim 6, wherein a lifting lug is fixed to the upper box body, a support block is fixed to the lower box body, one end of a movable connecting rod is movably connected to the lifting lug, an other end of the movable connecting rod is movably connected to a top of an electric push-pull bar, and a bottom of the electric push-pull bar is fixedly connected to the support block.

8. The cryogenic laser shock device according to claim 7, wherein the first automatic door, the second automatic door, a first solenoid valve, the vacuum pump, the first conveyor belt, the second conveyor belt, the one-dimensional motion platform, the third conveyor belt, the two-dimensional motion platform, the mechanical arm, a three-dimensional motion platform, a pulsed laser emitter, a servo motor, and a third solenoid valve are all connected to a first computer through a first controller; and
the cryogenic probe is connected to a second computer through a temperature sensor and is configured to measure the temperature of the sample in real time.

9. A cryogenic laser shock method, comprising:
S1: opening an upper box body, raising a support plate, placing a sample having an absorption layer on the support plate, then lowering the support plate, and closing the upper box body;
S2: opening a pressure relief valve and a second solenoid valve through a cryogenic control device to control a flow rate of nitrogen gas introduced into a cooling chamber; after a temperature of the sample is stabilized to T° C., controlling a second computer to close the pressure relief valve and the second solenoid valve; then turning on a vacuum pump to pump out gas in the cooling chamber; after the gas in the cooling chamber is pumped out, disconnecting a quick joint from a pumping hose, and placing a cooling box on a first conveyor belt;
S3: opening a first automatic door through a first computer, transporting the cooling box from the first conveyor belt to a second conveyor belt, then closing the first automatic door, opening a first solenoid valve, and pumping out gas in a transition chamber;
S4: opening a second automatic door, transporting the sample to a third conveyor belt, opening the upper box body through a box movement device, raising the support plate, then taking out the sample by a mechanical arm, transporting the sample to a position such that an end surface of a shock head end cap is 15 mm to 25 mm away from the sample to be peened, adjusting a laser energy, a laser spot diameter, a laser frequency, a laser pulse width, and a laser spot overlap rate, then performing pre-shocking in a laser shock chamber in a vacuum state for 2 min, and performing laser shock peening; and
S5: after the shock peening is completed, placing the sample on the support plate, then lowering the support plate, mounting the upper box body, transporting the cooling box to the second conveyor belt, then closing the second automatic door, opening the first automatic door, transporting the cooling box to the first conveyor belt, finally taking out the sample so that an entire shock process is completed, turning off all the devices, and repeating S1 to S5 to implement a next shock process.
